(19) United States
(12) Patent Application Publication
(10) Pub. No.: US 2009/0205329 A1
(43) Pub. Date: Aug. 20, 2009

(54) Heat engine matched to cheap heat source or sink

(76) Inventor: Niket Patwardhan, San Jose, CA (US)

Correspondence Address: Niket Patwardhan, P.O. Box 675, Santa Clara, CA, 95052, US

(21) Appl. No.: 12/316,870

(22) Filed: Dec. 17, 2008

Related U.S. Application Data
(63) Continuation-in-part of application No. 10/394,849, filed on Mar. 22, 2003, now Pat. No. 7,481,057.
(60) Provisional application No. 60/369,059, filed on Apr. 1, 2002.

(51) Int. Cl. F02G 1/043

(52) U.S. Cl. 60/517

(57) ABSTRACT

This invention teaches how to build heat engines that can work with low temperature heat sources with the input working fluid being air at ambient temperature and pressure.

### PRIORITY DATE BENEFIT CLAIM

This application is a continuation-in-part of U.S. application Ser. No. 10/394,849, filed Mar. 22, 2003, which claims the benefit of U.S. Provisional Application No. 60/369059, filed Apr. 1, 2002.

### STATEMENT REGARDING FEDERALLY SPONSORED RESEARCH OR DEVELOPMENT

Not Applicable

### REFERENCE TO A MICROFICHE APPENDIX

Not Applicable

### SPECIFICATION

The specification and drawings, but not the claims, of U.S. application Ser. No. 10/394,849 are incorporated by reference. The primary drawing for this application should be FIG. 5 of the above application.

### ADDITIONAL SPECIFICATION

Part of the above specification describes a gas engine whose components are arranged in such a manner that it avoids the need for extracting work from the fluid during or after the expansion step and replacing it before or during the compression step.

This is necessary in most gas engines because the work is present in the fluid after expansion as kinetic energy (meaning the fluid is moving at high velocity) and it is very, very hard to cool a high velocity fluid without significant losses—because the heat must eventually be rejected to the environment and normally the environment is at standstill with respect to the engine. The exception is a jet engine attached to an airplane in flight. Efficient heat transfer to/from a fluid in a small space requires intimate contact between the fluid and the cooling medium, but this also means high viscous forces on the fluid if it is moving fast with respect to the cooling medium. In normal gas engines this is solved by extracting the kinetic energy from the fluid before cooling, and reintroducing it during the compression phase.

Unfortunately, turbines and compressors between them typically lose between 10-20% of the work they transfer from and to the fluid, and if the theoretical thermal efficiency between the operating temperature points is less than that, the engine cannot function as a net generator of work Another problem is that most air based gas engines are open-cycle, and the low temperature end is the environment, so the expansion step must necessarily follow the compression step.

The solution to this was to 1) place the expansion step before the compression step so the kinetic energy generated by the expansion step could be transferred in the fluid to the compression step without requiring transfer to parts of the engine and then back, and 2) inject a finely divided low temperature liquid with a high thermal capacity into the gas with as little as possible relative motion between the liquid and the gas. This solves the problem of getting heat out of the fast moving gas with low losses, but now we have fast moving droplets that need to be re-extracted with low losses. There are two approaches to this—the original specification required that the compression be near isothermal and dynamic, with the droplets remaining in the gas until compression was almost done and the kinetic energy mostly consumed, thus ensuring that the droplets (and gas) were relatively slow moving and still near the low temperature end of the cycle on exit from the compressor, thus making possible the efficient extraction of the coolant from the gas.

Calculations on water and air showed that it is even possible to add just enough water that all the droplets completely vaporize before the compression brings the pressure back to the starting pressure or above, and the remaining kinetic energy to near zero. If an open cycle is acceptable, then one justs exhausts to the environment—otherwise one can slightly cool the slow moving mixture of air and water vapor to get the water to recondense. In an open cycle the extraction happens in the environment. Then one can continue the cycle, heating the recompressed and dried air to the upper end of the cycle.

This results in a cycle that has a constant pressure heating phase, an adiabatic power extraction expansion phase, and a near isothermal compression phase. In the solar power context of U.S. application Ser. No. 10/394849, this provided the advantage that the solar panels could be the heater part of the engine, and work with ambient pressure air as the intake fluid—resulting in a single pipe from the roof of a building to the engine generating the power. Additionally, a simple regenerative heat storage device could be used, since the full temperature range between the upper and lower temperatures (20-100 C) was available for heat storage. Most common materials as well as air have relatively constant Cp in the target temperature range. About 3 cubic meters of water with this kind of temperature range is sufficient to store the heat necessary to power a home through one full 24 hour period. The disadvantage is that the TS diagram of the cycle is approximately a triangle, making the theoretical efficiency about ½ the Carnot efficiency between the same two temperatures.

The fact that one can allow the droplets to evaporate in an open cycle without losing the ability to generate power suggests other applications.

One can substitute liquid nitrogen instead of water as the coolant. There will be an adiabatic expansion from ambient conditions, mixing with the liquid air at low pressure and high velocity until the liquid air droplets evaporate, and then adiabatic recompression back to ambient pressure. The engine works because the latent heat of evaporation of the liquid nitrogen absorbs more than enough heat to generate enough work for the recompression of the air and the gaseous nitrogen back to ambient pressure. Depending on how much liquid air is added, the exhaust will be cooler than ambient by a variable amount. The more liquid that is added, the cooler the exhaust will be, and the more power that will be developed. Absolutely no solid heat exchangers are required!

Note that since the cycle ends with an adiabatic recompression the TS diagram looks much more like a Brayton cycle or a Carnot cycle than the triangle of the previous implementation. This engine can therefore approach Carnot efficiencies.

Because the low point of this cycle is well below ambient (unless we consider radiation to deep space in the external process that generates the liquid nitrogen) there is no hope of generating net power using this process when one includes the cost of generating the liquid nitrogen. But one can use this as a means to store and distribute free energy with respect to ambient conditions in LN2, and then recover it efficiently and avoiding expensive heat exchangers and concomittant fouling problems in an automobile.

Extraction of the net free energy can happen by installing a turbine at the exit of the compressor, or by installing a pre-expander (which could be a turbine or some other compressed air device) ahead of the main expander. To ensure that the engine can keep running, a control device can be installed to limit the amount of energy extracted by the pre-expander.

I claim:

1. A device that converts heat energy into mechanical energy using a cycle optimized for low temperature differentials comprising:
a heater to heat a fluid at constant pressure;
an expander to expand the fluid adiabatically to the low temperature to convert heat into work;
and a compressor to compress the fluid to the starting temperature and pressure;
wherein the components are arranged so that the fluid goes through them in a specific order: heat, expand, compress;
and wherein the work that is required by the compression step is derived from the expansion step;
and wherein this work is for the most part left in the fluid and is not transferred to any other part of the engine between the expansion and compression step.

2. The device of claim 1 optimized for a low cost heat source or heat storage wherein:
the heater heats the fluid at constant pressure all the way from near the low temperature point of the cycle to the high temperature point;
the compression step is isothermal or near iso-thermal.

3. The device of claim 2 wherein:
the fluid is air;
the expander consists of one or more nozzles to expand hot air and convert some of its heat energy into kinetic energy;
a mixing section into which the nozzles deliver the air;
a water injector that atomizes and sprays water through the mixing section at high velocity thus cooling the air with little relative motion between the air and water;
a diffuser that compresses the mixture at low pressure and with high kinetic energy back to the input pressure or above.

4. The device of claim 3 where:
the nozzles are arranged in a circle and oriented to produce a swirling air mass above the water injector;
the water injector sprays water outward from just below the center of the swirling air mass;
and the mixing section is an annular gap in the enclosure that is aligned with the water spray from the atomizer.

5. The device of claim 4 where:
the water injector is a spinning wheel onto which water is dropped, or in whose axle a small channel delivers water or a low temperature liquid to the center of the wheel;
and the motive force for the wheel is a small motor that drives the wheel.

6. The device of claim I where:
the fluid is air;
the heating is accomplished by mixing the engine exhaust with ambient air;
the coolant is liquid air or liquid nitrogen instead of water.

7. The device of claim 1,2,3,4,5 or 6 where:
a pre-expander is placed ahead of the main expander, that extracts the net work of the system;
and a control device ensures that the pre-expander leaves enough available energy for the main expander to keep the engine running.
